(19) United States
(12) Patent Application Publication
(10) Pub. No.: US 2010/0050308 A1
(43) Pub. Date: Mar. 4, 2010

(54) Protective Clothing

(76) Inventors: Colin Roberson, Warwickshire (GB); Godfrey Hands, Warwickshire (GB)

Correspondence Address: HAYNES AND BOONE, LLP;IP Section, 2323 Victory Avenue, Suite 700, Dallas, TX, 75219, US

(21) Appl. No.: 11/887,644

(22) PCT Filed: Mar. 22, 2006
(86) PCT No.: PCT/GB2006/001066

§ 371 Date: Oct. 26, 2009

(30) Foreign Application Priority Data
Mar. 29, 2005 (GB) 0506293.0
Aug. 3, 2005 (GB) 0516009.8

(51) Int. Cl. F41H 1/02; G01M 7/00

(52) U.S. Cl. 2/2.5; 73/574

(57) ABSTRACT

An insert (10) for use in clothing designed to protect against bullets or knife attacks includes an upper layer (14) having a ceramic matrix. A pair of plugs (20) are fitted to the ceramic layer (14), the plugs (20) being made from a material having an impedance to vibration substantially the same as that of the ceramic matrix at the point of manufacture. The plugs (20) are configured for conducting mechanical vibration through the ceramic layer (14), for recording a vibration-related signature for the insert (10). By comparing a series of such signatures recorded over time, it is possible to assess whether the internal structure of the ceramic matrix has become damaged, which is useful in determining whether the insert needs to be replaced or repaired.

The present invention relates to an insert, more particularly, but not exclusively, to an insert for use in protective clothing. The invention also relates to an apparatus and method for testing such an insert, and to a garment incorporating said insert,

Body armour is an essential part of the protective clothing used by front line personnel in the Armed Services. It is also becoming increasingly prevalent amongst Police Force personnel.

A known form of body armour consists of a garment, such as jacket or waistcoat type garment, incorporating a plurality of plate type inserts. In the case of such garments, the inserts are often strategically positioned on the garment to protect against fatal bullet, knife or shrapnel wounds to the wearer's internal organs, in particular the heart.

This form of body armour can become damaged in service. Therefore, there is need to inspect the integrity of the inserts on a regular basis to make sure that each insert is in good working condition. A problem with such inserts is that, whilst the outward appearance of an insert may suggest that it is in good condition, the internal structure of the insert might be sufficiently damaged so as to adversely affect its performance in the field.

Hence, there is a need for a body armour insert which can be readily assessed for damage to its internal structure, preferably in the field.

It is an object of the invention to provide an improved insert for body armour type protective clothing and a method for testing the same which addresses the problems referred to above.

Accordingly, there is provided an insert for use in protective clothing, the insert including a body of a first material, the body further having a contact region adapted for connection to a vibration generator and a contact region adapted for connection to a vibration receiver. The contact regions may be separate regions of the body. Alternatively, the contact regions may be defined by a single common region of the body.

Accordingly, there is further provided an insert for use in protective clothing, the insert comprising a body having a matrix of a first material, the body further having a first contact region adapted for connection to a vibration generator and a second contact region adapted for connection to a vibration receiver, wherein first and second contacts are provided for use at the first and second contact regions for conducting vibration through the matrix, the contacts being formed from a second material, and wherein the normal impedance to vibration of the insert matrix is substantially the same as the normal impedance to vibration of the contacts.

The wording “impedance to vibration” is used herein to refer to a property of the material in question, for example the material forming the matrix and/or the contacts. It is intended to mean the impedance of the material to the conduction of vibration therethrough. The vibration to which the body may be subjected may be one of a number of forms, for example mechanical, ultrasonic or acoustic. In each case it will be understood that the relevant impedance to vibration will be that which matches the vibration to which the body is subjected such as, for example, acoustic impedance, mechanical impedance, or ultrasonic impedance.

The invention is advantageous in that a vibration generator and vibration receiver can be readily coupled to the insert, for conducting vibration through the matrix, via the contacts, to record a signature or ‘finger print’ for the insert.

A first signature can be recorded at the point of manufacture of the insert, for example. This can then be compared with a signature recorded after a period of use of the insert. If the internal structure of the matrix has become damaged in the period following manufacture or first recordal, a discrepancy will exist between the two signatures. The severity of the discrepancy can then be assessed, to determine whether the insert should be replaced or reissued for active service.

In a preferred embodiment, the body of the insert comprises a ceramic matrix.

The vibration generator is preferably a mechanical vibration generator.

According to a further aspect of the invention, there is provided a method of testing an insert, according to claim 23.

According to a still further aspect of the invention, there is provided an apparatus for testing an insert, according to claim 28.

According to a yet further aspect of the invention, there is provided a garment incorporating an insert according to the first aspect of the invention.

Other preferred features and advantages of the invention will be readily apparent from the claims and the following description, which is made, by way of example only, with reference to the accompanying drawings, in which:

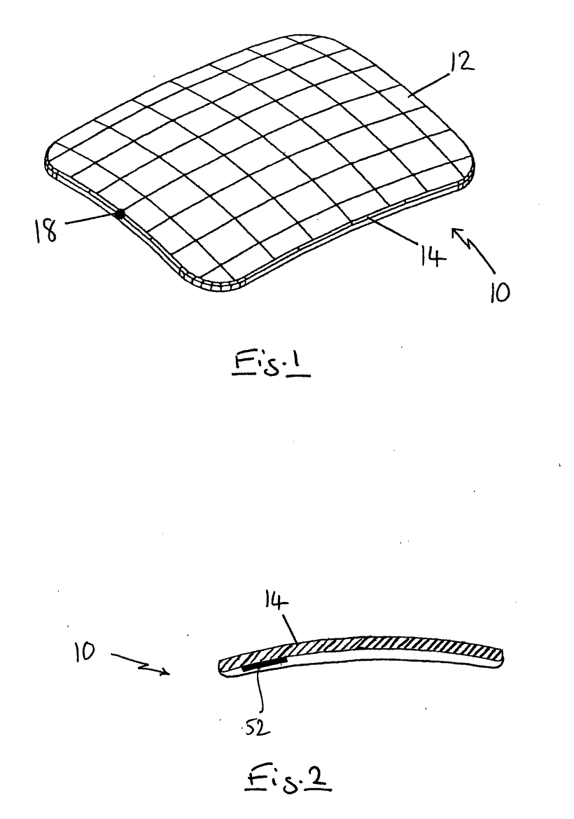

FIG. 1 is a schematic perspective view of a body armour plate in accordance with a preferred embodiment of the invention;

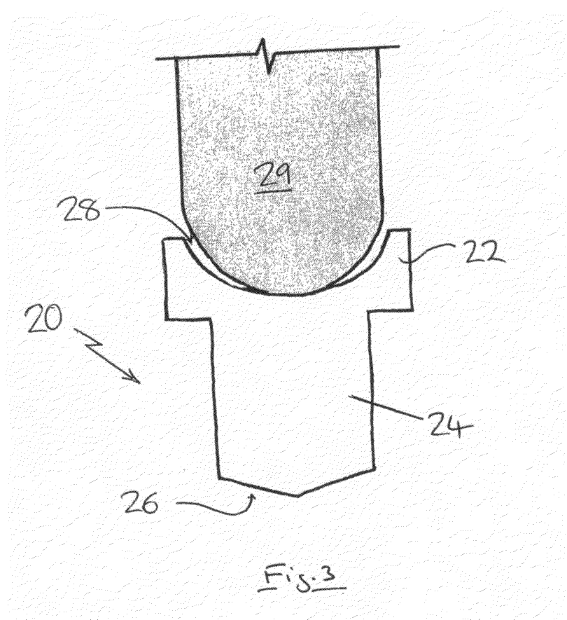

FIG. 2 is a schematic cross-sectional view of the plate shown in FIG. 1;

FIG. 3 is a schematic cross-sectional view of a testing plug for use in the plate shown in FIGS. 1 and 2;

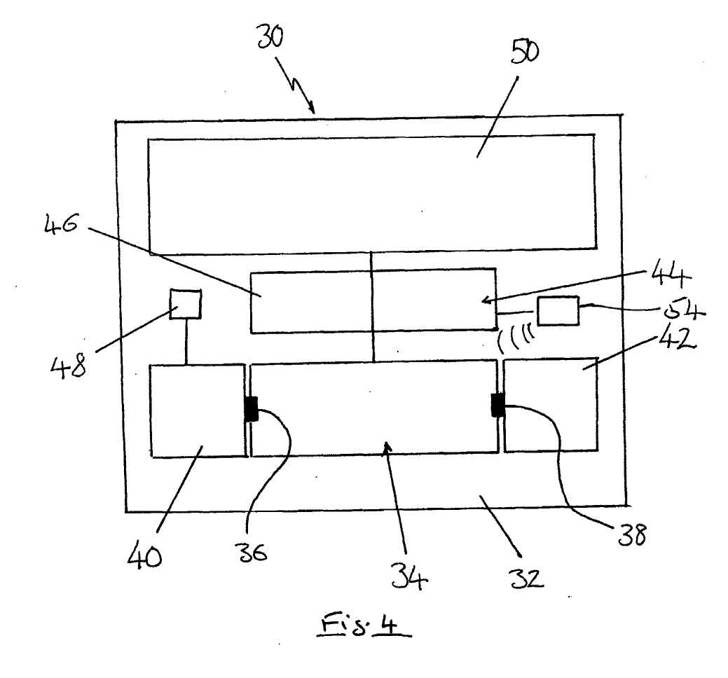

FIG. 4 is a schematic partial block diagram of a testing apparatus in accordance with a further preferred embodiment of the invention;

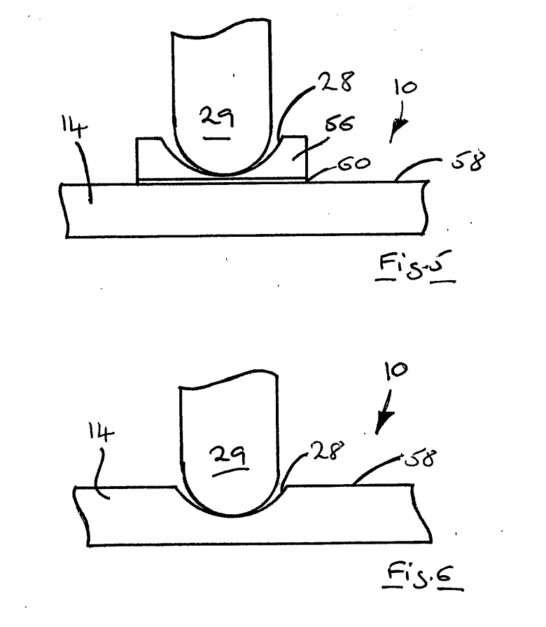

FIG. 5 is a schematic cross-sectional view an alternative embodiment of a testing site for the plate of FIGS. 1 and 2; and

FIG. 6 is a schematic cross-sectional view of another alternative embodiment of a testing site for the plate of FIGS. 1 and 2.

Referring to FIGS. 1 and 2, an insert in accordance with a preferred embodiment of the invention is in the form of a body armour plate, indicated generally at 10. The plate 10 consists of a generally rectangular body portion 12 of shallow convex cross-section, in both the longitudinal and lateral directions.

The body portion 12 has an upper layer 14, which in this embodiment is made from ceramic material such as aluminium oxide, boron carbide or silicon carbide, in a manner known to those persons skilled in the art. It should be noted that the ceramic material provides an internal matrix within the upper layer 14 having a known impedance to vibration. Other suitable materials can also be used, such as metal composites and glass-type materials, with an internal or external structure which is suitable for the conduction of vibration therethrough.

The body portion 12 may also include a composite backing layer (not shown) made from textile, which is common in the art and not described in further detail. The backing layer is bonded to the underside of the body portion 12, as viewed in FIG. 1, in a known manner. The upper ceramic layer 14 may optionally be contained within a removable textile coat or sleeve (not shown).

A pair of circular diameter blind recesses 18, only one of which is clearly visible in FIG. 1, are provided in opposing side edges of the ceramic layer 14. The recesses 18 define first and second contact regions or test zones in the plate 10, and are configured for receiving a test contact of complimentary diameter, not illustrated in FIG. 1, but described in more detail below with reference to FIG. 3.

Although not illustrated, the plate 10 has a thin layer of foam or fabric material, for example Kevlar (RTM), as an outer covering or jacket, with a movable portion provided in the region of each test zone, to allow selective access to the test zones for testing of the plate 10.

The plate 10 is designed for use as an insert in a protective garment, such as a protective jacket, vest or waistcoat. The upper layer 14 is intended to face outwardly, in use, and is configured for providing protection against injury from ballistic weapons, stabbing-type attacks and shrapnel or the like, i.e. to prevent the passage of a bullet, blade or other sharp object through the garment in the area of the insert.

Referring now to FIG. 3, a plug for use as a test contact for the plate 10 is indicated in generally at 20. The plug 20 is substantially T-shaped and defines a head portion 22 and a central shaft 24. The plug 20 includes a pointed tip 26 for securing the plug 20 at a test zone.

A hemispherical recess 28 is formed in the head portion 22, which is configured for receiving a complimentarily formed contact portion of a vibration generator or a vibration receiver, an example of which is indicated generally at 29. It will be appreciated that the recess does not need to be hemispherical and other shapes and configurations of recess may be utilised.

The shaft 22 is configured for being received in a blind recess in an insert, such as the recesses 18 in the plate 10 described above, with the underside of the head portion 26 abutted against an outer surface of the insert.

In this embodiment, the plug 20 is formed from metal, more particularly brass, having a normal impedance to vibration which is substantially the same as that of the ceramic matrix of the plate 10. By utilising a contact having the same or substantially the same impedance to vibration, vibration can be conducted into the matrix of the insert, via a plug 20, without significant attenuation or reflection at the interface between the contact and the matrix.

The plugs 20 are preferably affixed in the recesses 18 during manufacture of the plate 10. The manner of fixing should be chosen to significantly exclude any air pockets between a plug 20 and its respective recess 18, since the presence of air gaps can lead to an attenuation or reflection of vibration passing through the plug 20 or ceramic matrix, in use.

In a preferred embodiment of the invention, the plugs 20 are affixed using an adhesive compound incorporating a metallic matrix having identical impedance to vibration properties to the plug 20, whereby the plug 20 and adhesive compound form a direct interface with the internal walls of the respective recess 18. Alternatively, the plugs 20 can be configured to be secured in the recesses 18 in an interference fit, for example.

A method of testing the plate 10 utilising the plugs 20 will now be described.

Firstly, an inspection probe having a mechanical vibration generator (not illustrated) is connected to a first plug 20 at one of the test zones, with an inspection device having a vibration receiver/detector (not illustrated) coupled to a plug 20 at the other test zone. The probe is then energised to generate mechanical vibration, which is conducted into the upper layer 14 via the first plug 20. The vibration passes through the matrix of the upper layer 14 and is recorded at the second test zone by the vibration receiver, via the opposing plug 20. It will be appreciated that different forms of vibration generator may be employed depending upon such factors as, for example, the material properties of material forming the plate 10. For example, an acoustic vibration generator or, alternatively, an ultrasonic vibration generator may be employed. It will be understood that the specific type of vibration generator will need to be matched with an appropriate and complementary vibration receiver.

By utilising plugs 20 having substantially the same normal impedance to vibration as the matrix of the upper layer 14, the vibration generated by the probe is able to pass between the interfaces of the plugs 20 and the upper layer 14 without significant reflection or attenuation at the interfaces.

The recorded vibration can be used to provide a signature or “finger print” for the plate 10, as described in more detail below.

A first signature is recorded at the point of manufacture, or at least prior to use, to provide a signature characteristic of an unused, undamaged ceramic layer 14. This characteristic signature is then stored, for example on a computer memory, memory disc or electronic identification tag.

The integrity of the upper layer 14 of the plate 10 can be assessed at any time after manufacture or use by recording another signature in the manner described above and then comparing the new signature with the characteristic signature. If the newly detected signature differs significantly from the stored signature, this indicates that the upper layer 14 has been damaged in some way. Even minor damage to the matrix of a body armour plate can be detected using this method. This enables a user to assess the risk of potential failure of the plate in respect of the detected damage, in order to help determine whether the armour plate should be repaired, replaced or reissued for use in the field.

This non-destructive form of testing is ideally suited for use in the field, whereby a portable inspection generator and receiver can be readily coupled to a body armour plate, for testing, for example in situ.

A preferred method of recording a signature using the contact/matrix combination described above involves the sequential excitation of a vibration generator arranged to conduct vibration through the matrix via the plugs/contact regions. Preferably, each excitation has the same duration but has a different frequency or range of frequencies. For example, each excitation may have a set duration of 1 millisecond, with the first excitation having a frequency of 100 Hz and the frequency of each subsequent excitation rising by 100 Hz. The values or vibration wave form detected in response to each excitation is then used to build up a signature for the insert being tested.

Referring now to FIG. 4, a battery powered test unit in accordance with a preferred embodiment of the invention is indicated generally at 30. The unit 30 includes a housing 32 having an aperture 34 defining a recess for receiving and supporting a body armour insert substantially as described above, in a cassette like manner. It will be appreciated that the unit 30 may be powered by means other than a battery. For example, the unit 30 may be connectable to a mains supply, a portable generator, or a power point of a vehicle.

An inspection probe 40 having a mechanical vibration generator is mounted in the housing 32. The probe 40 includes a first inspection contact 36 for engagement with a test zone of an insert to be tested. An inspection device 42 having a vibration receiver/detector is also mounted in the housing 32. The inspection device 42 provides the unit 30 with a second inspection contact 38 for engagement with a different test zone of an insert to be tested. It will be appreciated that different forms of vibration generator may be employed depending upon such factors as, for example, the material properties of material forming the plate 10. For example, an acoustic vibration generator or, alternatively, an ultrasonic vibration generator may be employed. It will be understood that the specific type of vibration generator will need to be matched with an appropriate and complementary vibration receiver.

In this embodiment, the inspection contacts 36, 38 are arranged for coupling to a pair of opposing test plugs 18 inserted into the housing 32. To that end, the first and or second inspection contacts 36, 38 are movable within the housing 32 into intimate engagement with their respective test plug of an insert so disposed.

At this point it should be noted that the inspection contacts 36, 38 can themselves be made from a material having the same impedance to vibration as the internal matrix structure of the object to be tested. Moreover, the inspection contacts 36, 38 can comprise the test contacts, whereby the test contacts are moved within the housing into direct and intimate engagement with the respective contact regions of the object, for recording a signature of the object.

The unit 30 includes a microprocessor 44 in communication with the probe 40 and receiver 42. The microprocessor 44 includes a memory portion 46 programmed with database of individual identification data for a batch of said body armour inserts, including the characteristic signature data for each insert.

The housing 32 also includes a switch 48 for energising the probe 40, so as to initiate a signature test on an insert received in the aperture 34, and a visual display 50 for communicating the results of said test.

In use, an armour insert is introduced into the aperture 34, whereupon the contacts 36, 38 come into positive connection with the test zones of the insert. The switch 48 is then depressed, so that the probe 40 is energised and mechanical vibration is passed from the probe 40 into the insert via the connection between the first contact 36 and a first test zone in the insert. As described above, the vibration passes through the body of the insert and is collected by the receiver 42 via the opposing test zone.

The microprocessor 44 is then able to compare the collected signature against the stored signature data for said plate. The microprocessor 44 is programmed to identify whether a significant difference is present between the two signatures, and to send a signal to the display 50, indicative of the state of the ceramic layer of the plate. For example, a red light could be used to show that a plate is damaged above a certain threshold and should not be used further, whereas a green light could be used to indicate that a plate is undamaged or at least insufficiently damaged so as to adversely affect its field performance. Alternatively, or additionally, the two or more signatures can be shown on the display 50 for visual interpretation.

The test apparatus provides a convenient means for testing the integrity of body armour inserts in the field, so as to prevent internally damaged inserts from being issued to service personnel. The test apparatus analyses the component resonances or Eigen frequencies

It will be appreciated that the test unit 30 will require accurate calibration before being able to operate a green light/red light determination of plate quality. One method of calibrating the test unit involves the gathering of a plurality of reference plates. The reference plates range in structural integrity from undamaged to shattered and may be inserted in to the unit to program the microprocessor as to the characteristic signatures of plates of differing structural quality and integrity. The integrity of the reference plates may be determined using a number of techniques including, for example, inspection of a range of plates by digital radiography. It will be appreciated that the reference plates may be used periodically to verify the accuracy of the test unit 30.

Although the invention has been described with reference to inserts or plates having only two contact regions or test zones, it will be appreciated that any number of test zones could be utilised. For example, a rectangular insert may include a plurality of opposing pairs of test recesses, whether in parallel, and/or from corner to corner, and/or in the lateral and longitudinal axes of the insert. Similarly, a generally circular or irregular shaped plate could be provided with a plurality of pairs of diametrically opposed test contacts, uniformly spaced about the circumference of the plate.

An insert or plate according to the present invention may also be provided with a single contact region or test zone. In such an embodiment, it will be appreciated that the recess 28 receives the contact portion 29 of a combined vibration generator and receiver.

The test plugs described above are used to provided a contact between the body of the insert and the vibration devices. It should be noted that any suitable contact may be utilised, wherein suitable vibration can be conducted from a probe or other such generator into the insert, without significant attenuation or reflection at the interface with the internal matrix structure of the insert. For example, a contact portion can be formed directly on the surface of an insert, by adhesively affixing a component to act as a contact region. Alternatively, a compound incorporating a suitable metallic matrix can be bonded to a predetermined region of the insert. Other suitable methods will be readily apparent to a person skilled in the art, such as riveting or clamping a metallic element to the insert. It should be noted that the contacts may be formed from the same material as the insert matrix.

Referring now to FIGS. 5 and 6 there are shown alternative configurations of a portion of the plate 10 arranged to co-operate with the contact portion 29 of a vibration generator, vibration receiver, or combined vibration generator and receiver. In FIG. 5 the recess 28 for receiving the contact portion 29 is provided in a member 56 attached to the surface 58 of the ceramic layer 14 of the plate 10. The member 56 may be manufactured from the same material as the plate 10. Alternatively, the member 56 may be manufactured form a different material to the plate 10. In such an embodiment the member is manufactured from a material having a normal impedance to vibration which is substantially the same as that of the material of the plate. In the embodiment shown the member 56 is attached to the plate 10 by a layer of adhesive 60. In FIG. 6, the recess 20 is formed directly in the surface 58 of the ceramic layer 14 of the plate 10.

Plates 10 having configurations corresponding to those described with reference to FIGS. 5 and 6 are tested in the same manner as described above in relation to FIG. 4. In yet a further alternative embodiment, the portion of the plate 10 arranged to co-operate with the contact portion 29 of a vibration generator, vibration receiver, or combined vibration generator and receiver may comprise a projection of the plate 10. As described above, the or each projection may be formed or moulded integrally to the plate 10 or, alternatively, may be attached to the plate 10 by adhesive for example.

It should also be noted that each insert may be provided with an electronic identification means or other readable device, for storing the characteristic signature data for the insert and other identification data such as date of manufacture and first issue. This data is then readable during testing, for example by the microprocessor in the testing apparatus described above in a manner known in the art, which obviates the need for a separate database or memory disc of stored diagnostic data.

For example, the plate 10 may be provided with a remotely readable data storage device such as, for example, an radio frequency identification (RFID) tag. FIG. 2 shows such a tag, designated 52, mounted to a rear surface of the plate 10. The tag 52 may, for example, be attached to the plate 10 with adhesive. It will be appreciated that the tag 52 may be mounted to the plate 10 at other locations and in other manners. For example, the tag 52 may be mounted to a peripheral edge of the plate 10. Alternatively, where the plate 10 is of a laminar construction, the tag 52 may be incorporated within the body of the plate 10 between layers thereof.

The tag 52 contains a unique identifier for the plate 10 such as, for example, a serial number. The tag 52 is intended to retain the identifier for the service life of the plate 10. In use, the tag 52 is read by reader 54 present within the test unit 30 (FIG. 4). The reader 54 is connected to the microprocessor 44 of the test unit. Upon insertion of a plate 10 into the test unit 30, the tag 52 is interrogated by the reader 54 and the unique identifier for the plate 10 obtained. The identifier is passed to the microprocessor 44 which retrieves from the memory thereof the signature for the particular plate 10. The plate 10 is tested in the manner described above and the signature obtained compared with the signature retrieved from the memory. The microprocessor 44 then determines whether or not the plate 10 is fit for reissue. In instances where it is deemed fit, the operator is informed accordingly and the memory is updated to reflect that the plate 10 has passed. In the event that the plate 10 fails, the operator is again informed and a the memory is updated to reflect that the plate 10 having the given identifier is no longer fit for use. The test unit 30 may further advise an operator as to when a particular plate has passed an advisory expiry date and indicate that the plate 10 should be sent for refurbishment or downgraded for reserve usage.

In an alternative embodiment the tag 52 may include a memory which is configured to store a previously obtained signature for the plate 10. The signature stored by the tag 52 may correspond to an original test conducted prior to the first issue of the plate 10 or, alternatively, to the last time the plate 10 was tested.

It will be appreciated that other forms of information storage and display may be used in conjunction with or as an alternative to the tag 52. For example, the plate may be provided with printed information in the form of a serial number comprising a string of numbers and letters, or a barcode. Where a barcode is provided, the test unit 30 is provided with an optical barcode reader.

Although the invention has been described with particular reference to inserts having a ceramic matrix, it will be appreciated that other suitable materials can also be used, such as metal composites and glass-type materials, with an internal or external structure which is suitable for the conduction of vibration therethrough. The inserts can be of any desired shape or configuration, such as circular or irregular, with single or double curvature, or a planar configuration.

It should be noted that the invention is not wholly limited to an insert for use in protective clothing, but extends to any object to be tested having a matrix of a first material, wherein the object further includes a first contact region adapted for connection to a vibration generator and a second contact region adapted for connection to a vibration receiver, and wherein first and second contacts are provided for use at the first and second contact regions for conducting vibration through the matrix, the contacts being formed from a second material, and wherein the normal impedance to vibration of the insert matrix is substantially the same as the normal impedance to vibration of the contacts.

It should further be noted that there is also provided a further aspect of the invention, largely in accordance with the above described embodiments.

According to this further aspect of the invention, there is provided an object comprising a body having a matrix of a first material, the body further having a contact region adapted for connection to a vibration generator, and a contact for use at the contact region for conducting vibration through the matrix, the contact being formed from a second material, and wherein the normal impedance to vibration of said matrix is substantially the same as the normal impedance to vibration of the contact.

According to this aspect of the invention, a single direct contact (e.g. a plug 20 as describe above) at a single test zone (e.g. a blind recess 18 as described above) can be utilised to record a signature for the object to be tested, substantially in the manner described above. With the contact suitably located at the contact region, i.e. to prevent or significantly reduce attenuation of vibration at the interface between the contact and the matrix of the object, vibration can be conducted into the matrix of the object via the contact. For example, an ultrasonic probe can be coupled to the contact in a suitable attenuation reducing manner and then the probe can be energised to conduct ultrasonic vibration into the matrix of the insert, via the contact. An ultrasonic wave receiver can be coupled to or placed in close proximity to the object for recording the level or wave form of the ultrasonic vibration passing through the matrix of the object. Hence, a signature for the object can be recorded, substantially in the manner described above.

It will be appreciated that a comparison of previously recorded signatures can then be used to assess the state of the insert in the manner described above.

A method of testing, a test apparatus and a garment incorporating the object in accordance with this further aspect of the invention are therefore also foreshadowed, substantially in accordance with the above description and the applicant hereby reserves the right to apply for independent protection for these aspects.

1. An insert for use in protective clothing, the insert including a body of a first material, the body further having a contact region adapted for connection to a vibration generator and a contact region adapted for connection to a vibration receiver.

2. An insert according to claim 1 wherein the body is provided with a first contact region adapted for connection to a vibration generator and a second contact region adapted for connection to a vibration receiver,

3. An insert according to claim 1 or claim 2, wherein the body comprises a ceramic matrix.

4. An insert according to any of claims 1 to 3, wherein the or each contact region is in direct contact with the material of the body.

5. An insert according to any of claims 1 to 4, wherein the or each contact region comprises a recess formed in the material of the body.

6. An insert according to any of claims 1 to 3 wherein the or each contact region is defined by a contact member attached to the body.

7. An insert according to claim 6 wherein the or each contact member is formed from the same material as the body.

8. An insert according to claim 6 wherein the or each contact member is formed from a second material, and wherein the normal impedance to vibration of the material of the body is substantially the same as the normal impedance to vibration of the material of the or each contact member.

9. An insert according to claim 8, wherein the or each contact member comprises a plug received in a recess of the body.

10. An insert according to any of claims 6 to 9, wherein the or each contact member is affixed to the body using adhesive.

11. An insert according to any of claims 6 to 10, wherein the or each contact member comprises a metallic material.

12. An insert according to claim 11, wherein the or each contact member is formed from brass.

13. An insert according to any preceding claim, wherein the insert is of a composite construction have a first layer containing the material forming the body.

14. An insert according to claim 13, wherein the insert comprises a second layer comprising a woven textile material.

15. An insert according to any preceding claim, wherein the insert includes an outer covering.

16. An insert according to claim 15, wherein the outer covering includes a movable portion adjacent each or each contact region, for selective access thereto.

17. An insert according to claim 15 wherein the outer covering is removable.

18. An insert according to claim 2 or any of claims 3 to 17 when dependent upon claim 2, wherein first and second contact regions are diametrically opposed to one another with respect to the body.

19. An insert according to any preceding claim, further including a readable device for storing characteristic data for identification of the insert.

20. An insert according to claim 19 wherein said readable device is a serial number.

21. An insert according to claim 19 wherein said readable device is a barcode.

22. An insert according to claim 19 wherein said readable device is an RFID device.

23. A method of testing an insert for use in protective clothing, the insert comprising a body of a first material, the body further having a contact region for connection to a vibration generator and a vibration receiver, the method comprising the steps of:
a) coupling a vibration generator to the contact region;
b) coupling a vibration receiver to the contact region;
c) energising said vibration generator to conduct vibration through said body via said first contact; and
d) collecting the vibration through the vibration receiver, so as to record a signature for said insert.

24. A method according to claim 23, wherein a first signature is recorded prior to use or transit of said insert, and then a second signature is recorded after a period of use or transit of said insert, for comparison with said first signature, for assessing whether the insert has incurred damage to its structure.

25. A method according to claim 23 or claim 24, wherein the vibration generator comprises a mechanical vibration generator.

26. A method according to any of claims 23 to 25, wherein the step of energising the vibration generator comprises the step of sequential excitation of the vibration generator at different frequencies or ranges of different frequencies.

27. A method according to claim 26 wherein each excitation of the vibration generator has the same duration.

28. An apparatus for testing an insert for use in protective clothing, the insert comprising a body having of a first material, the body further having a contact region adapted for connection to a vibration generator and a contact region adapted for connection to a vibration receiver, the apparatus comprising an insert receiving region for removably receiving an insert, the region including at least one insert contact for connection to the contact regions of said insert, a vibration generator and a vibration receiver, the apparatus being configured for selectively energising said vibration generator for conducting vibration into an insert received in said insert receiving region and for recording a signature for an insert so positioned.

29. An apparatus according to claim 28, wherein the vibration generator comprises a mechanical vibration generator.

30. An apparatus according to claim 28 or claim 29, wherein the apparatus includes means for storing said signatures.

31. An apparatus according to any of claims 28 to 30, wherein the apparatus includes means for comparing said signatures.

32. An apparatus according to any of claims 28 to 31, wherein the apparatus includes means for viewing said signatures.

33. A garment incorporating an insert according to any of claims 1 to 22.
